(19) United States
(12) Patent Application Publication
(10) Pub. No.: US 2019/0002092 A1
(43) Pub. Date: Jan. 3, 2019

(54) AIRCRAFT LANDING GEAR ASSEMBLY

(71) Applicant: Airbus Operations Limited, Bristol (GB)

(72) Inventor: Robert Ian THOMPSON, Bristol (GB)

(21) Appl. No.: 16/018,617

(22) Filed: Jun. 26, 2018

(30) Foreign Application Priority Data
Jun. 30, 2017 (GB) 1710573.5

(51) Int. Cl. B64C 25/60; B64D 45/00; F16F 9/32; B64C 25/40; G01F 1/38

(52) U.S. Cl. CPC B64C 25/60; B64D 45/00; B64C 25/44; B64C 25/40; G01F 1/383; F16F 9/3292

(57) ABSTRACT

An aircraft landing gear assembly (112) including a shock absorber strut (114), a bogie (120), a link assembly (124), and a movement detector (132). The shock absorber strut includes an upper and a lower telescoping parts (118, 116), the upper part being connectable to the airframe of an aircraft and the lower part being connected to the bogie. The link assembly extends between the upper and lower telescoping parts. The movement detector detects movement of the link assembly relative to the bogie. The movement detector includes: a piston (138) arranged such that relative movement between the link assembly and the bogie causes relative movement of the piston within a cylinder (136); fluid which flows as a result of relative movement between the piston and the cylinder; and a flow sensor (184) arranged to sense a change in flow due to movement of the piston within the cylinder.

### BACKGROUND OF THE INVENTION

The present invention concerns aircraft landing gear. More particularly, but not exclusively, this invention concerns an apparatus and a method for detecting aircraft weight on wheels during an aircraft landing. The invention also concerns a wing assembly and an aircraft including such a landing gear assembly.

FIG. 2 shows a typical prior art landing gear assembly 12 for an aircraft. The landing gear assembly 12 comprises a shock absorber strut 14 comprising a piston 16 received within a cylinder 18. Cylinder 18 is connected to the airframe of the aircraft. Piston 16 is at its lower end pivotally connected to a bogie 20. The bogie 20 can thereby adopt different pitch angles relative the shock absorber strut 14. A pitch trimmer 24 controls the position of the bogie 20 relative to the shock absorber strut 14 in flight. A plurality of wheels 22 are mounted on the bogie 20.

The in-flight angle of the bogie relative to the shock absorber strut (the “trail angle”) is typically set by the pitch trimmer to facilitate the retraction of the landing gear into the available space within the wheel well in the airframe. The trail angle may mean that during landing all the wheels do not touch the ground at the same time. For example, in FIG. 2 it can be seen that should the aircraft travelling in direction F land on the ground G, the rear wheel 22a will touch down in advance of the front wheel 22b.

There are various prior art methods of detecting aircraft weight on wheels during landing. The detection of weight on wheels can act as a trigger condition for the initiation of various aircraft retardation devices (for example brakes, lift dumpers, engine reverse thrust). Thus it can be understood that the sooner aircraft weight on wheels can be detected, potentially the sooner the aircraft can be slowed and, if required, brought to a stop.

One such prior art method of detecting weight on wheels involves detecting shock absorber compression. The trail angle, and the fact that the bogie is pivotally connected to the shock absorber, may mean that the shock absorber does not immediately compress, despite one or more of the wheels having touched down (i.e. despite there being weight on those wheels). For example, with reference to FIG. 2, in a landing of the aircraft on the ground G, the rear wheel 22a will touch down in advance of the front wheel 22b. However it will not be until be until there is also weight going through the front wheel 22b, and sufficient weight going through the shock absorber 14, that weight on wheels will be detected using this method. The minimum amount of weight going through the shock absorber to cause compression is known as the “breakout load”. The magnitude of the breakout load is a result of (i) a minimum pressure needed to keep the seals energised within the shock absorber and (ii) the overall shape of the shock absorber spring curve. This may result in a breakout load of several tonnes. Particularly for a low sink rate, low weight landing, the shock absorbers may not breakout immediately. This may result in late weight on wheels detection and therefore late braking in these circumstances.

Another prior art method of detecting weight on wheels involves detecting spin-up of the wheels of the aircraft. In certain conditions, for example for landings on icy runways or runways contaminated with oil, there may be a delay in the wheels spinning up after they have touched down. Therefore there may again be a delay in detecting weight on wheels.

As mentioned above, the in-air trail angle is typically set by the pitch trimmer to facilitate the retraction of the landing gear into the available space within the wheel well in the airframe. Pitch trimmers may be active or passive. Passive trimmers usually provide a force that orientates the bogie to a particular position. This can be achieved by applying a hydraulic pressure to a piston. In this case no position feedback or control function is required. Active trimmers can control the orientation of the bogie such that it can be made to adopt one of a number of positions.

In a certain prior art landing gear assembly there is provided a proximity sensor having a discrete output that indicates whether or not the bogie is at the correct trail angle to permit landing gear retraction. Movement away from this position could, during landing, be used to detect weight on wheels. However, should the pitch trimmer fail and allow the bogie to drift away from the correct trail angle during flight, aircraft weight on wheels could not be detected using this method. Therefore use of the proximity sensor in such a way would not be a sufficiently reliable method for detecting aircraft weight on wheels. Further, this method may also fail to detect weight on wheels should the aircraft land square on the bogie, such that all wheels contact the ground at once and there is limited movement of the bogie relative to the shock absorber strut.

The present invention seeks to mitigate one or more of the above-mentioned problems. Alternatively or additionally, the present invention seeks to provide an improved apparatus for detecting aircraft weight on wheels.

### SUMMARY OF THE INVENTION

The present invention provides, according to a first aspect, an aircraft landing gear assembly comprising: a shock absorber strut, a bogie, a link assembly, and a movement detector. The shock absorber strut comprises an upper and a lower telescoping parts, the upper part being connectable to the airframe of an aircraft and the lower part being connected to the bogie such that the bogie may adopt different pitch angles. The link assembly extends between the upper and lower telescoping parts, such that relative movement between the upper and lower telescoping parts causes relative movement between parts of the link assembly. The movement detector is arranged to detect movement of the link assembly relative to the bogie. Wherein the movement detector comprises: a piston slidably received within a cylinder, arranged such that relative movement between the link assembly and the bogie causes relative movement of the piston within the cylinder, fluid which flows as a result of relative movement between the piston and the cylinder, and a flow sensor arranged to sense a change in flow of the fluid, wherein relative movement between the link assembly and the bogie is detected by the flow sensor detecting a change in flow due to movement of the piston within the cylinder.

Embodiments of the aircraft landing gear assembly of the first aspect may provide several benefits over the aforementioned prior art. Firstly, the assembly does not rely only on shock absorber compression before weight on wheels can be detected. Similarly, the assembly does not rely only on the movement of the bogie relative to the shock absorber strut for detection of weight on wheels. By the use of fluid flow between two chambers the movement detector is able to detect movement of the link assembly relative to the bogie irrespective of their relative initial positions. The assembly therefore need not rely on the pitch trimmer bringing the bogie to a predetermined position in order to detect aircraft weight on wheels during landing, because the movement detector can detect movement of the link assembly with respect to the bogie regardless of the initial position of the link assembly and the bogie. The aircraft landing gear assembly according to the present invention advantageously detects aircraft weight on wheels due to compression of the shock absorber (which causes movement of the link assembly) and/or a change in trail angle during landing, in spite of failure conditions of the pitch trimmer.

It will be appreciated that there may be certain arrangements of the assembly in which no relative movement of the link assembly and bogie occurs at a particular landing angle because the movement of the bogie cancels out the movement of the link assembly when the shock absorber compresses. However it has been found that the assembly can be arranged to mitigate or eliminate the possibility of this happening under most foreseeable circumstances.

The upper part (or the lower part) of the shock absorber strut may be a cylinder part. The lower part (or the upper part) of the shock absorber strut may be a piston part or a slider part. The piston part or slider part may be arranged to be received within the cylinder part. This may permit telescopic movement such that the shock absorber strut can vary in length. The length of the shock absorber strut may vary depending on the amount of load applied to the shock absorber strut in the direction of the longitudinal axis of the shock absorber strut. The internal cavity formed by the upper and lower parts of the shock absorber strut may contain gas, which may be contained under pressure. The gas may act as a spring and may at least partially support the aircraft weight when on the ground. The cavity may also contain a volume of hydraulic fluid (e.g. oil). The hydraulic fluid may be forced through restrictors to provide damping (i.e. to control the rate of movement of the slider).

The link assembly, being connected between the upper and lower telescoping parts of the shock absorber strut, is caused to move when the shock absorber strut compresses or extends. Therefore when load is applied to (or removed from) the shock absorber strut, for example during landing of an aircraft, the link assembly will be caused to move. In use the link assembly and the bogie may have an initial relative position at a given time. The given time may be after the landing gear assembly has been deployed for landing and before the aircraft has touched down. The link assembly, the bogie and the movement detector may be so arranged that the movement detector detects relative movement, from an initial position, between the link assembly and the bogie, irrespective of the initial positions of the link assembly and the bogie. The link assembly may extend between, and be directly connected to, the upper and lower telescoping parts.

The landing gear may comprise a torque link assembly. The torque link assembly may be arranged to resist rotation of the upper part of the shock absorber strut relative to the lower part of the shock absorber strut, about the longitudinal axis of the shock absorber. The landing gear may comprise a false link assembly (sometimes referred to as a slave link assembly). The false link assembly may not itself be arranged to resist rotation. The false link assembly may provide an alternative route for the electrical and hydraulic dressings that connect to wheel mounted systems (brakes, tachometers, tyre pressure sensors etc.) segregated from the route available over the torque link assembly. The link assembly (whose relative movement is detected) may be either the toque link assembly or the false link assembly. In some embodiments the movement of more than one link assembly relative to the bogie may be detected.

The movement detector and/or link assembly may be positioned fore or aft of the shock absorber strut. Positioning the movement detector and/or link assembly aft of the shock absorber strut may be advantageous as it may at least be partially shielded by the shock absorber strut during flight, for example against bird strike.

The link assembly may comprise an upper arm and a lower arm. The upper arm may be pivotally connected to the upper part of the shock absorber strut. The lower arm may be pivotally connected to the lower part of the shock absorber strut. The upper and lower arms may be pivotally connected to each other at a hinge location. When the shock absorber strut is compressed, the hinge location may be forced outwards and away from the shock absorber strut. The upper arm may be directly connected to the upper part of the shock absorber strut (i.e. not via any other link arms or the like). The lower arm may be directly connected to the lower part of the shock absorber strut.

The movement detector may be connected at one end to the link assembly. That end of the movement detector may be attached to the link assembly at a location that, along the length of the link assembly when at its most open, is closer to the hinge location than to the either end of the link assembly. The movement detector may be mounted to the link assembly at, or directly adjacent to, the hinge location of the link assembly. The movement detector may be mounted to the link assembly at the hinge location. For example, the upper arm may be pivotally connected to the lower arm by an axial pin extending through the upper arm and lower arm. The movement detector may be mounted at the axial pin, for example being mounted on the axial pin.

The movement detector may be arranged to detect movement of the upper arm and/or the lower arm relative to the bogie. The movement detector may be mounted to the upper arm and/or lower arm. The movement detector may be pivotally mounted at one end to the upper arm and/or lower arm. The movement detector may be mounted to the upper and/or lower arm at a location between the two ends of the upper arm and/or lower arm. The movement detector may be arranged to detect the angle of the upper arm and/or the lower arm relative to the bogie.

The bogie may comprise a bogie beam extending fore and aft. The bogie may comprise one or more axles. One or more wheels may be mounted on the one or more axles. For example, the bogie may comprise two axles, or three axles, each axle having two wheels. The shock absorber strut may be pivotally connected to the bogie. The movement detector may be mounted at one end to the bogie. The movement detector may be mounted to the bogie fore or aft of the location at which the shock absorber strut connects to the bogie.

The movement detector may comprise a member, or series of members, connected to and extending between the link assembly and the bogie. The movement detector may detect movement of one of its ends relative to the other. The movement detector may detect linear movement or rotational movement.

The movement detector may be connected to, and extend between, the link assembly and the bogie. The cylinder may be pivotally connected to the link assembly or bogie. The piston may be pivotally connected, via a piston rod, to the link assembly or bogie.

The movement detector uses fluid flow as a means of detecting whether the piston has moved in the cylinder and therefore whether the link assembly has moved relative to the bogie. If there is fluid flow then it can be determined that the piston is moving in the cylinder and therefore the link assembly is moving relative to the bogie. If the direction and/or speed of fluid flow can be determined then it may be possible to determine the direction and/or speed at which the piston is moving in the cylinder and therefore the direction and/or speed at which the link assembly is moving relative to the bogie. If there is movement, and/or movement above a certain rate, during landing then it can be determined that there is aircraft weight on wheels.

The speed at which the link assembly moves relative to the bogie during landing may correspond to the descent rate of the aircraft upon landing. The movement detector, when configured to determine speed of movement, may therefore also be used to determine the descent speed (i.e. the speed in the vertical direction) of the aircraft upon landing (e.g. immediately after touchdown of one or more wheels). The determination of descent speed may be made by a signal processor and/or a control system. The speed profile and/or the vertical deceleration of the aircraft during landing may also be determined.

If the aircraft descent rate during landing has exceeded a certain level, then it may be required to inspect the aircraft. In particular the landing gear assembly and/or the airframe may need to be inspected for distorted or failed parts. Typically aircraft descent rate is detected using, for example, a radar altimeter. The movement detector of the present invention may provide a more accurate measure of aircraft descent rate during landing. Therefore the present invention provides a way to determine, with more confidence, whether there is a need to inspect the aircraft. This may reduce the amount of unnecessary (and often time consuming) aircraft inspections.

According to another aspect of the invention there may be provided a method of determining the rate of descent of an aircraft upon landing. The method may comprise a step of determining, on the basis of the speed at which the link assembly moves relative to the bogie, the rate of descent of the aircraft. The speed at which the link assembly moves relative to the bogie may be determined using a movement detector according to the present invention. There may be a step of determining, on the basis of the rate of descent, whether to inspect the aircraft. According to another aspect of the invention there may be a method of using the movement detector in the determination of the rate of descent of an aircraft upon landing.

The cylinder may comprise a first chamber. The piston may cause movement of the fluid in the first chamber. The sensor may be arranged to sense the movement of the fluid in the first chamber. Preferably the movement detector comprises a second chamber, the second chamber being in fluid communication with the first chamber by a conduit. Movement of the piston within the cylinder may cause fluid flow between the first chamber and the second chamber. The sensor may be arranged to sense fluid flow in a conduit, for example a conduit between the first and second chambers. The total volume of the first and second chambers may not change as the piston moves. The fluid is preferably a hydraulic fluid. The fluid is preferably a liquid, which is preferably substantially incompressible.

The piston may push (or pull) fluid between the first chamber and the second chamber as it moves. Preferably the cylinder comprises the second chamber. The first and second chamber are preferably separated by the piston. A movement of the piston in the direction of the first chamber may cause the volume of the first chamber to decrease and the volume of the second chamber to increase by a corresponding amount, or vice versa. The pressure of the fluid in the first chamber may thereby increase relative to the pressure of the fluid in the second chamber, or vice versa. The pressures may equalise by way of fluid flow through the conduit.

The piston rod may extend along the longitudinal axis of the cylinder. The piston rod preferably extends through both chambers so that the total volume of the first and second chambers does not change as the piston moves.

The average pressure of the fluid in the chambers is preferably sufficient to energise dynamic seals in the movement detector, and may not be substantially higher. Preferably the pressure is sufficient to maintain a differential pressure across the dynamic seals under substantially all foreseeable operating conditions. Preferably the pressure is slightly above that of the local atmosphere. Maintaining such a pressure, and keeping the device completely filled with hydraulic fluid, may help reduce moisture ingress. By way of example the pressure may be about 100 psi.

The movement detector may comprise an accumulator arranged to maintain the average pressure of the volume of fluid. The accumulator may act to top-up the fluid in the chambers should fluid be lost, for example by leaking through seals. A non-return valve and/or flow restrictor may be provided between the accumulator and the chambers to prevent or reduce back flow into the accumulator. In use, the accumulator may or may not be connected to the aircraft hydraulic system.

Preferably the cross-sectional area of the conduit is relatively large to permit substantially free flow of fluid between the first and second chambers when the piston moves. Consequently there may be a low pressure differential between the first chamber and the second chamber during movement of the piston.

The conduit may comprise a constricted section. The constricted section having a reduced cross-sectional area, as compared to the cross-sectional area of the conduit either side of the constricted section. The speed of fluid flow through the conduit may increase in the constricted section. The sensor may sense the flow of fluid through the constricted section. The increase in the speed of a fluid flowing through a constricted section of pipe is known as the Venturi effect. Such conduits are therefore sometimes referred to as Venturi tubes.

The sensor may have an output that indicates whether the speed of the fluid flow is zero or non-zero. The sensor may have an output that indicates whether the speed of the fluid flow is below or above a threshold level. The sensor may have an output that indicates the speed of the fluid flow (i.e. an output on the basis of which the speed of fluid flow can be determined). For example the output may be proportional to the speed of the fluid flow. The sensor, or an additional sensor, may have an output that indicates the direction of the fluid flow. Thus the sensor(s) may have an output that indicates the velocity of the fluid flow. The output may be in the form of an electrical signal.

There may be a control system in communication with the sensor. The control system may comprise, or consist of, a signal processor. The control system may be able to interpret the signal received from the sensor and determine, on the basis of the signal, whether there is fluid flow in the conduit, and therefore whether the piston has moved within the cylinder, and therefore whether the torque link has moved relative to the bogie. The control system may also be able to determine, on the basis of the sensor output, the direction, speed and/or acceleration of the movement of the torque link relative to the bogie. The control system may thus be arranged to determine, on the basis of the sensor output, whether there is aircraft weight on wheels. The control system may provide an energising current and/or voltage to the sensors such that they can function. It will be understood that the control system may process the signals received from the sensor and may output a modified signal. The control system need not necessarily have control of any particular external or physical operations.

The control system may be arranged to determine that there is aircraft weight on wheels if the speed of fluid flow is non-zero. The control system may be arranged to determine that there is aircraft weight on wheels if the speed of fluid flow is above a threshold level. The threshold speed may be set such that movement of the link assembly relative to the bogie due to vibrations, and/or in-flight drift of the trail angle, do not meet the threshold. This may help mitigate false indications of aircraft weight on wheels.

The control system, may be arranged to generate a binary output indicating whether or not aircraft weight on wheels is detected. For example the output may be an “on” signal when aircraft weight on wheels is detected and an “off” signal when aircraft weight on wheels is not detected.

The control system may be integral to the movement detector. The control system may be remote from the movement detector. The control system may be an aircraft control system, for example being located in another part of the aircraft remote from the landing gear.

It will be understood that the signal output by the sensor may take various forms. The signal could be a direct or alternating current. The voltage, current and/or frequency of the signal may be related to the speed of fluid flow. The signal may be discrete, for example on/off. There could be a baseline signal when the speed of fluid flow is zero or below a threshold amount and another signal when the fluid flow is non-zero or above a threshold amount. In other embodiments the signal could be an analogue or digital waveform which encodes information, for example a true/false indication or a numerical value.

The sensor may comprise a hot wire transducer. The sensor may comprise a hot film transducer. The sensor may comprise an ultrasonic flow meter. The sensor may therefore comprise a pair of ultrasonic transducers. The sensor may comprise a pressure transducer. There may be a plurality of pressure transducers. There may be a first pressure transducer arranged to measure the pressure in the constricted section. There may be a second pressure transducer arranged to measure the pressure in the conduit to one side of the constricted section. There may be a third pressure transducer arranged to measure the pressure in the conduit to the other side of the constricted section. The second and third pressure transducers may be used in addition to the first pressure transducer or alternatively used instead of the first pressure transducer. Thus, there may be a pair of transducers arranged to measure the pressure either side of the constricted section.

The sensor is preferably arranged to sense the fluid flow using a static detection methodology. For example the sensor may be in the form of a static detection means and/or the flow detecting parts of the sensor are static in nature. The sensor may therefore not comprise any moving parts that are used for sensing fluid flow in the conduit. Preferably the sensor is hermetically sealed against atmospheric pressure fluctuations.

The movement detector may comprise a body mounted to the cylinder. Preferably the body is detachably mounted. The conduit may be located in the body. The sensor may be mounted on the body. Locating the conduit in, and/or mounting the sensors on, a detachable body may make replacement, repair and/or manufacture of these elements of the system easier and/or more convenient.

The landing gear assembly may comprise a pitch trimmer arranged to move the bogie so as to adopt a particular trail angle. The pitch trimmer may be active or passive. The pitch trimmer may be provided in addition to the movement detector. Alternatively, the movement detector may be formed as a part of the pitch trimmer.

The present invention provides, according to a second aspect, a method of detecting aircraft weight on wheels during a landing of an aircraft. The aircraft comprises a control system and a landing gear assembly. The landing gear assembly comprises: a shock absorber strut, a bogie, a link assembly, and a movement detector. The shock absorber strut comprises an upper and a lower telescoping parts, the upper part being connected to the airframe of the aircraft and the lower part being connected to the bogie such that the bogie may adopt different pitch angles. The link assembly extends between the upper and lower telescoping parts, such that relative movement between the upper and lower telescoping parts causes relative movement between parts of the link assembly. The bogie supports at least one wheel on at least one axle. The movement detector comprises: a piston slidably received within a cylinder, wherein movement of the piston within the cylinder causes fluid to flow in the movement detector, a sensor being arranged to detect the fluid flow. The method comprises the following steps. The link assembly moving relative to the bogie during touchdown of the least one wheel thereby causing the piston to move within the cylinder and fluid to flow through the conduit. The sensor sensing the fluid flow in the conduit. The control system receiving a signal from the sensor, the signal being indicative of fluid flow in the conduit. The control system determining, on the basis of the signal, that there is aircraft weight on wheels.

The landing gear assembly may be a landing gear assembly according to the first aspect of the invention. The link assembly moving relative to the bogie during touchdown of the least one wheel may cause the piston to move within the cylinder and fluid to flow through the conduit. The sensor may sense the fluid flow in the conduit. The control system may receive a signal from the sensor, the signal being indicative of fluid flow in the conduit.

The step of sensing may simply comprise sensing whether or not there is a non-zero rate of flow, or whether or not the speed of the fluid flow is above a threshold level. The signal may therefore comprise a binary indication of whether or not there is a non-zero rate of flow, or whether or not the rate of flow is above the threshold. Preferably the step of sensing comprises sensing the speed and/or direction of the fluid flow. The signal received by the control signal may therefore be indicative of the speed and/or direction of the fluid flow.

The control system may determine there to be aircraft weight on wheels when there is an indication of non-zero fluid flow, or an indication of fluid flow above a threshold level. There may also be a step of the control system determining the direction and/or speed of movement of the link assembly relative to the bogie.

There may be a step of determining whether or not the aircraft is sufficiently close to landing to begin to determine whether there is aircraft weight on wheels. For example, it may only be useful to attempt to detect aircraft weight on wheels when the aircraft is below a certain altitude, or at a certain location, and touchdown of the one or more wheels is imminent.

The method may comprise ascertaining the altitude of the aircraft, for example using a radar altimeter. The method may therefore comprise a step of determining whether the aircraft is below a certain altitude, and if so using the sensor to sense fluid flow. The altitude may for example be 30 feet, 20 feet or 10 feet above the ground. The method may comprise a step of ascertaining the aircraft location, for example using GPS. The method may comprise a step of determining whether the aircraft is at a certain location, and if so using the sensor to sense fluid flow. The location may for example be within the airport threshold, or within the runway threshold.

The link assembly may be deemed to have an initial position relative to the bogie at a particular point in time. For example the initial relative position may be deemed to be the position when the altitude or location conditions are first met for a given landing attempt. The method may therefore comprise sensing the fluid flow as the link assembly and bogie move away from the initial relative position.

One end of the movement detector, for example one end of the cylinder, may be connected to the link assembly. An opposing end of the movement detector, for example a free end of the piston rod, may be connected to the bogie.

The step of the link assembly moving relative to the bogie during touchdown might include the point on the link assembly to which the cylinder is attached moving towards or away from the point on the bogie to which the piston rod is attached. The movement of the link assembly with respect to the bogie may thus lead to the piston being moved into or out of the cylinder. This in turn may result in compression of the second chamber or first chamber. Whether there is extension or compression of the movement detector during landing may depend on the position of the movement detector, the orientation of the movement detector, and/or the trail angle.

The present invention provides, according to a third aspect, a method of slowing an aircraft, the method comprising the steps of: detecting whether there is aircraft weight on wheels according to the method of the second aspect of the invention, and deploying at least one means of slowing an aircraft when the control system determines there to be aircraft weight on wheels. The means of slowing an aircraft may, for example, include reverse thrust, lift dumpers and/or wheel braking. The method may more generally be a method of triggering the deployment of a means for slowing an aircraft.

In another aspect of the invention, there is provided an aircraft comprising a landing gear assembly according to any other aspect of the invention. The aircraft may comprise more than one landing gear assembly in accordance with the present invention. There may be one or more such landing gear assemblies located on opposite sides of the aircraft.

The aircraft may be a commercial aircraft, for example an aircraft configured to transport more than 50 passengers, for example more than 100 passengers, for example more than 200 passengers or an equivalent cargo load. The aircraft may be a commercial passenger aircraft. The aircraft may be a fixed wing aircraft.

In another aspect of the invention, there is provided a movement detector comprising: a piston slidably received within a cylinder, fluid which flows as a result of relative movement between the piston and the cylinder, and a flow sensor arranged to sense a change in flow of the fluid, wherein movement is detected by the flow sensor detecting a change in flow due to movement of the piston within the cylinder. The movement detector may comprise any of the features set out in relation to the first and/or second aspects of the invention. In particular, the cylinder preferably comprises a first chamber, the first chamber being in fluid communication with a second chamber by a conduit, a sensor being arranged to sense fluid flow in the conduit, wherein the movement detector is arranged such that movement of the piston within the cylinder causes fluid flow between the first chamber and the second chamber, and wherein movement of the piston relative to the cylinder is detected by the sensor detecting fluid flow in the conduit.

In another aspect of the invention there may be provided a method of determining the rate of descent of an aircraft upon landing. The method uses a landing gear assembly according to the present invention. The method comprises the steps of: the link assembly moving relative to the bogie during touchdown of the least one wheel thereby causing the piston to move within the cylinder and the fluid to flow; the sensor sensing the speed of fluid flow; the control system receiving a signal from the sensor, the signal being indicative of the speed of fluid flow; and a control system determining, on the basis of the signal, the rate of descent of the aircraft. The method may therefore comprise an intermediate step or concurrent step of the control system determining the speed at which the link assembly moves relative to the bogie. There may be a step of determining, on the basis of the rate of descent, whether to inspect the aircraft. According to another aspect of the invention there may be a method of using the movement detector in the determination of the rate of descent of an aircraft upon landing.

The present invention may provide, more generally, an aircraft landing gear assembly comprising: a shock absorber strut, a bogie, a link assembly, and a movement detector. The shock absorber strut comprises an upper and a lower telescoping parts, the upper part being connectable to the airframe of an aircraft and the lower part being connected to the bogie such that the bogie may adopt different pitch angles. The link assembly extends between the upper and lower telescoping parts, such that relative movement between the upper and lower telescoping parts causes relative movement between parts of the link assembly. In use the link assembly and the bogie have an initial relative position at a given time, and the movement detector is arranged to detect movement of the link assembly relative to the bogie irrespective of the initial relative position of the link assembly and the bogie. The movement detector may not necessarily comprise the piston and cylinder arrangement of the first aspect.

It will of course be appreciated that features described in relation to one aspect of the present invention may be incorporated into other aspects of the present invention. For example, the method of the invention may incorporate any of the features described with reference to the apparatus of the invention and vice versa.

The term ‘or’ shall be interpreted as ‘and/or’ unless the context requires otherwise. It will be understood that phrases to the effect of “movement of component x relative to component y”, “movement of component y relative to component x”, “relative movement of components x and y”, “movement of component x with respect to component y”, etc. are equivalent, are used interchangeably, and do not imply a particular component is stationary in a particular reference frame unless otherwise stated.

Alternative embodiments of a movement detector are described and claimed in both (a) UK patent application entitled “Aircraft Landing Gear Assembly” with agent's reference “P026752 GB” and marked with the reference “12010-GB-NP” in the header of the patent specification as filed and (b) UK patent application entitled “Aircraft Landing Gear Assembly” with agent's reference “P026754 GB” and marked with the reference “12211-GB-NP” in the header of the patent specification as filed, each application having the same filing date as the present application. The contents of those applications are fully incorporated herein by reference. The claims of the present application may incorporate any of the features disclosed in that patent application. In particular, the claims of the present application may be amended to include features relating to movement detector as set forth in the claims of either of the aforementioned other patent applications.

### DESCRIPTION OF THE DRAWINGS

Embodiments of the present invention will now be described by way of example only with reference to the accompanying schematic drawings of which:

FIG. 1 shows a side view of an aircraft comprising a landing gear assembly;

FIG. 2 shows a side view of a prior art landing gear assembly;

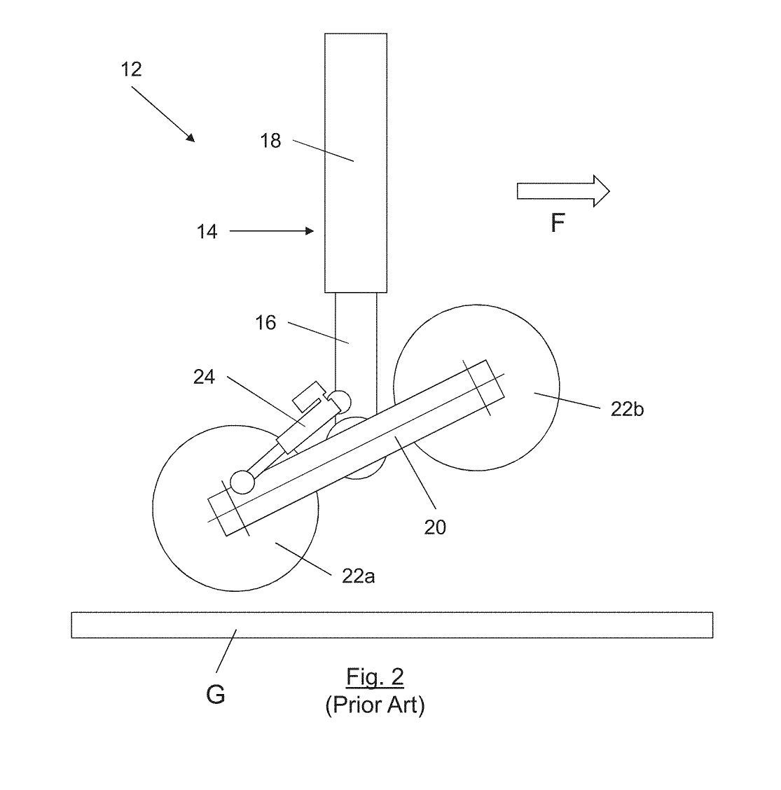

FIG. 3 shows a side view of a landing gear assembly according to a first embodiment of the invention prior to touchdown;

FIG. 4 shows a side view of a landing gear assembly according to a first embodiment of the invention after touchdown and before shock absorber compression;

FIG. 5 shows a side view of a landing gear assembly according to a first embodiment of the invention after shock absorber compression;

FIG. 6 shows a flow chart of a method of detecting aircraft weight on wheels according to a second embodiment of the invention;

FIG. 7 shows a cross-sectional view of a movement detector according to the first embodiment of the invention;

FIG. 8 shows a cross-sectional view of a movement detector according to the third embodiment of the invention;

FIG. 9 shows a cross-sectional view of a movement detector according to the fourth embodiment of the invention;

FIG. 10 shows a cross-sectional view of a movement detector according to the fifth embodiment of the invention; and

FIG. 11 shows a cross-sectional view of a movement detector according to the sixth embodiment of the invention.

### DETAILED DESCRIPTION

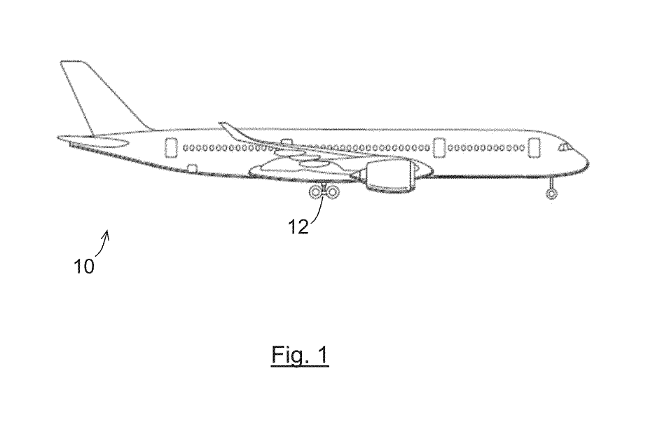

FIG. 1 shows an aircraft 10 comprising a main landing gear 12, the aircraft being of a type that may be employed as the aircraft with which the methods and apparatuses of any of the illustrated embodiments may be used. The aircraft 10 thus includes a landing gear assembly 12 including a bogie, which is mounted on the lower end of the landing gear leg in such a way that the bogie may adopt different pitch angles.

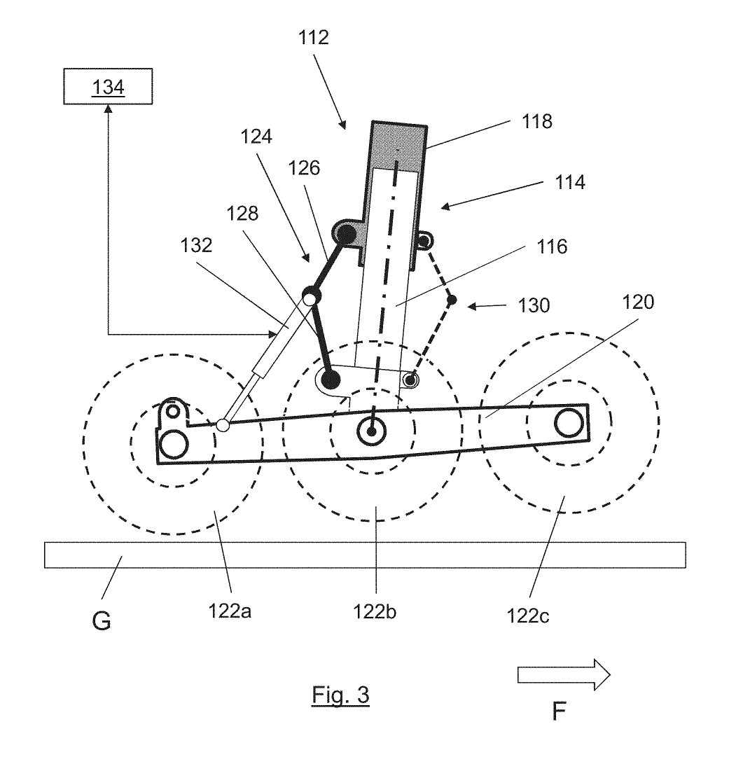

FIG. 3 shows an aircraft landing gear assembly 112 according to a first embodiment of the invention. The landing gear assembly 112 comprises a shock absorber strut 114 comprising a piston 116 received within a cylinder 118. Cylinder 118 is connected to the airframe of an aircraft. The direction of the front of the aircraft is indicated by arrow F. Piston 116 is at its lower end pivotally connected to a bogie 120. The bogie 120 can thereby adopt different pitch angles relative the shock absorber strut 114. A pitch trimmer (not shown) controls the position of the bogie 120 relative to the shock absorber strut 114 in flight.

A plurality of wheels 122 are mounted on the bogie 120. In this embodiment three pairs of wheels 122a, 122b, 122c are mounted to bogie 120 by three axles. A link assembly 124 in the form of a torque link connects the cylinder 118 and the piston 116 of the shock absorber strut. The link assembly 124 comprises an upper arm 126 which is pivotally mounted to the cylinder 118 and a lower arm 128 which is pivotally mounted to the piston 116. The upper arm 126 and lower arm 128 are pivotally attached to each other at a hinge location. The link assembly 124 acts against rotational movement of the piston 116/bogie 120 relative to the cylinder 118/airframe. FIG. 3 also shows a second link assembly 130 in the form of a false link.

A movement detector 132 extends between the link assembly 124 and the bogie 120. One end of the movement detector is pivotally connected to the link assembly 124 at the hinge location. An opposing end of the movement detector 132 is pivotally connected to the bogie 120 proximate the aft end of the bogie 120.

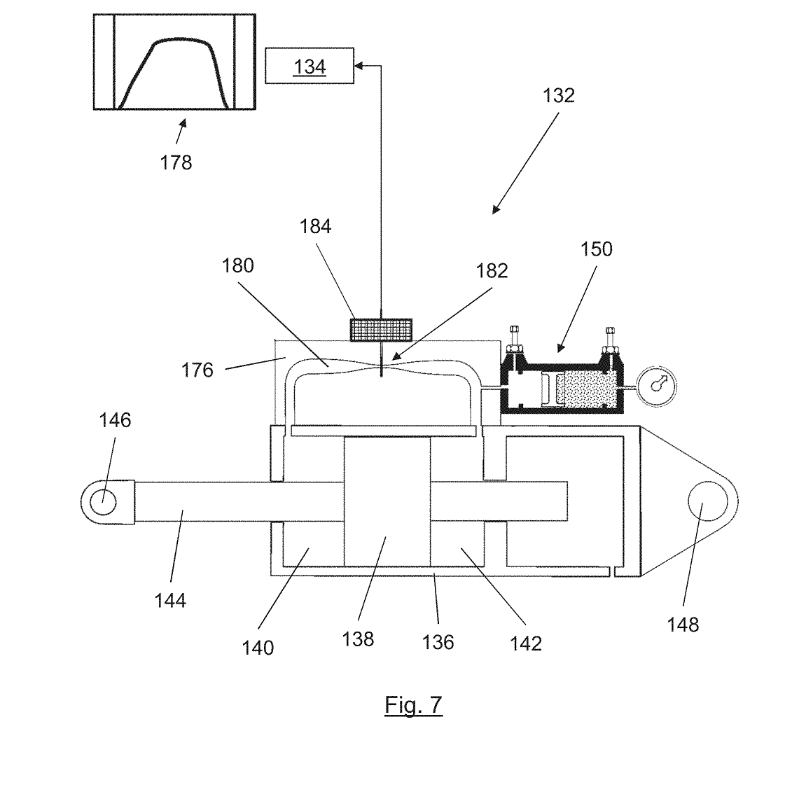

FIG. 7 shows the movement detector 132 in more detail. Movement detector 132 comprises a cylinder 136 having an internal space which houses a piston 138. The piston 138 divides the internal space into a first chamber 140 and a second chamber 142. The first chamber 140 and the second chamber 142 are filled with a hydraulic fluid. A hydraulic accumulator 150 keeps the hydraulic fluid in the first and second chambers 140, 142 topped up and at a substantially constant average pressure (PA).

The piston 138 is received on a piston rod 144 which extends through both end walls of the internal space. Two apertures 146, 148 are located at opposing ends of the movement detector. A first aperture 146 being located on the piston rod and a second aperture being located on the cylinder 136. The movement detector 132 is pivotally mounted to the bogie 120 and the link assembly 124 via the apertures 146, 148.

A conduit 180 puts the first chamber 140 into fluid communication with the second chamber 142. The conduit 180 connects with the first chamber 140 and second chamber 142 by inlet/outlet ports proximate the end walls of the chambers 140, 142 The conduit is located in a body 176 detachably mounted to the cylinder 136.

The conduit comprises a constricted section 182. The conduit 180 thereby forms a Venturi tube. A sensor in the form of a hot wire transducer 184 is arranged to measure the speed of the fluid flow in the constricted section 182 of the conduit 180.

A movement of the link assembly 124 relative to the bogie 120 causes compression or extension of the movement detector 132 and thereby causes movement of the piston 138 within the cylinder 136. Movement of the piston 138 within the cylinder 136 in turn causes fluid to flow between the first chamber 140 and the second chamber 142 via the conduit 180. The hot wire transducer 184 thereby measures a non-zero speed of fluid flow during a movement of the link assembly 124 relative to the bogie 120. Graph 178 shows an example of how the speed of fluid flow varies with time over a movement of the link assembly 124 relative to the bogie 120.

The hot wire transducer 184 is in communication with a control system 134 of the aircraft. The hot wire transducer 184 provides an output from which the control system 134 can determine the measured speed of the fluid flow. The control system 134 can thus determine whether (i) there has been movement of the link assembly 124 relative to the bogie 120 and (ii) therefore there is aircraft weight on wheels.

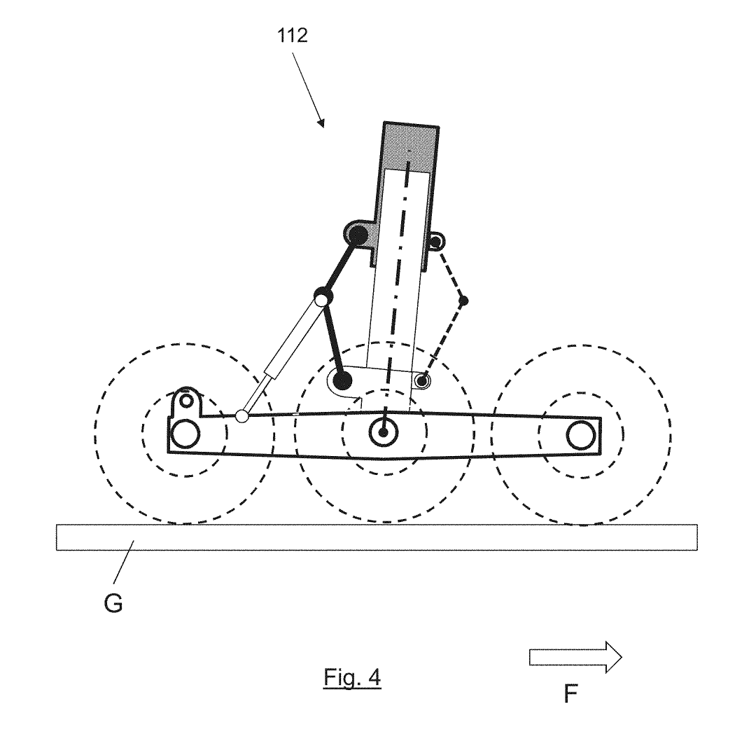

The landing gear assembly 112 of the first embodiment has a trail angle of less than 10 degrees. During landing of the aircraft the aft pair of wheels 122a touchdown first. The bogie 120 subsequently pivots around the bottom of the shock absorber strut 114 until the centre 122b and front 122c pair of wheels have also touched down. At which point the bogie 120 is oriented substantially parallel to the ground G. In the present arrangement, the movement detector 132 is therefore compressed, as shown in FIG. 4. The piston 138 will therefore move so as to cause fluid to flow from the second chamber 142 to the first chamber 142.

Until the centre 122b and front 122c pair of wheels have touched down, there is unlikely to be enough aircraft weight going through the shock absorber strut 114 to cause it to compress. The link assembly 124 will therefore remain stationary relative to the airframe during this initial movement of the bogie 120 relative to the link assembly 124.

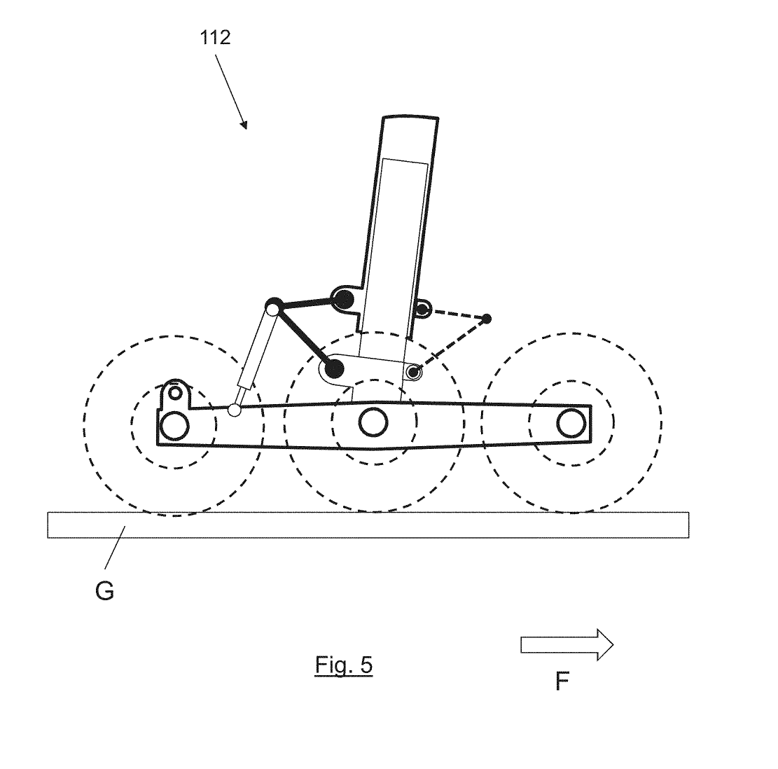

Thereafter, the shock absorber strut 114 begins to compress due to the weight of the aircraft. The link assembly 124 again moves relative to the bogie 120. The hinge location of the link assembly 124 moves aft and downwards. In the present arrangement this causes further compression of the movement detector 132, as shown in FIG. 5. There will therefore be further fluid flow from the second chamber 142 to the first chamber 142.

In the event of a flat landing of the bogie 120, in which all pairs of wheels 122 touchdown at substantially the same time, it will be seen that movement is still detected due to shock absorber 114 compression, despite there being no or negligible pivotal movement of the bogie 120 about the shock absorber strut 114.

The aircraft may land with a negative trail angle, such that the front pair of wheels 122c touch down before the rear pair of wheels 122a. In this case the aft portion of the bogie 120 will initially pivot away from the link assembly 124. Thus the movement detector 132 extends in length until the bogie 120 is parallel to the ground. The piston 138 will therefore move so as to cause fluid to flow from the first chamber 140 to the second chamber 140. Subsequent shock absorber 114 compression then moves the link assembly 124 back towards the point on the bogie 120 where the movement detector is attached, thus causing compression of the movement detector 132 and fluid flow back from the second chamber 142 to the first chamber 142. Both such movements could be used to detect aircraft weight on wheels, and could also be used to detect the time of shock absorber 114 compression.

In alternative embodiments the movement detector 132 may be mounted between the forward portion of the bogie 120 and the false link 130. In other alternative embodiments the movement detector 132 may be connected to the lower arm 128 below the hinge location.

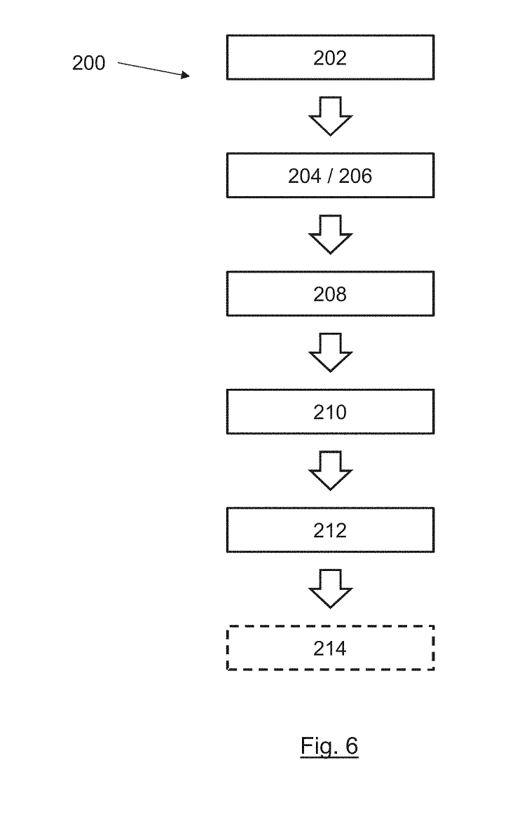

A method 200 of detecting aircraft weight on wheels will now be described according to a second embodiment of the invention and with reference to FIG. 6. The method will be described with reference to an aircraft landing gear assembly according to the first embodiment.

The method begins subsequent to deploying (lowering) the aircraft landing gear from the aircraft wheel well. However the method may include a step of lowering the aircraft landing gear. The first step includes the control system 134 determining 202, from a radar altimeter, whether the altitude is below a predetermined value, in this example whether the altitude is below 10 feet. Provided the altitude condition is met, i.e. provided the altitude is below 10 feet, the control system 134 is configured to use the signal received from the movement detector 132 to determine whether there is aircraft weight on wheels.

The method subsequently comprises a step of at least one wheel of the aircraft touching down 204 on the ground and concurrently the link assembly 124 moving 206 relative to the bogie 120. Depending on the orientation of the bogie 120 relative to the ground immediately prior to touchdown, and whether there is any equipment failures for example deflation of one or more of the tyres, the link assembly 124 moves relative to the bogie 120 by (i) the bogie 120 pivoting relative to the shock absorber strut 114 and/or (ii) the shock absorber strut 114 compressing thereby causing outward movement of the link assembly 124.

The movement of the link assembly 124 relative to the bogie 120 causes the piston 138 to move within the cylinder 136. This in turn causes the fluid present in the chambers 140, 142 to flow through the conduit. The flow will either be from the first chamber 140 to the second chamber 142 during expansion of the movement detector 132 or from the second chamber 142 to the first chamber 140 during compression of the movement detector 132.

The method comprises a step of the hot wire transducer 184 sensing 208 the speed of fluid flow through the conduit 180. The step of sensing 208 comprises the hot wire transducer 184 providing an output signal corresponding to the speed of fluid flow.

The method comprises a step of the control system 134 receiving 210 the signal output from the hot wire transducer 184. The control system is arranged to interpret this signal. The method comprises a step of the control system 134 determining 212, on the basis of the signal, that there is aircraft weight on wheels. The control system 134 determines there to be aircraft weight on wheels when the speed of fluid flow is non-zero. In other embodiments the control system 134 determines there to be aircraft weight on wheels when the speed of fluid flow is above a threshold amount.

The method of the second embodiment may be a part of a method of slowing an aircraft. In which case there is a subsequent step of deploying 214 at least one means of slowing the aircraft when the control system determines there to be aircraft weight on wheels.

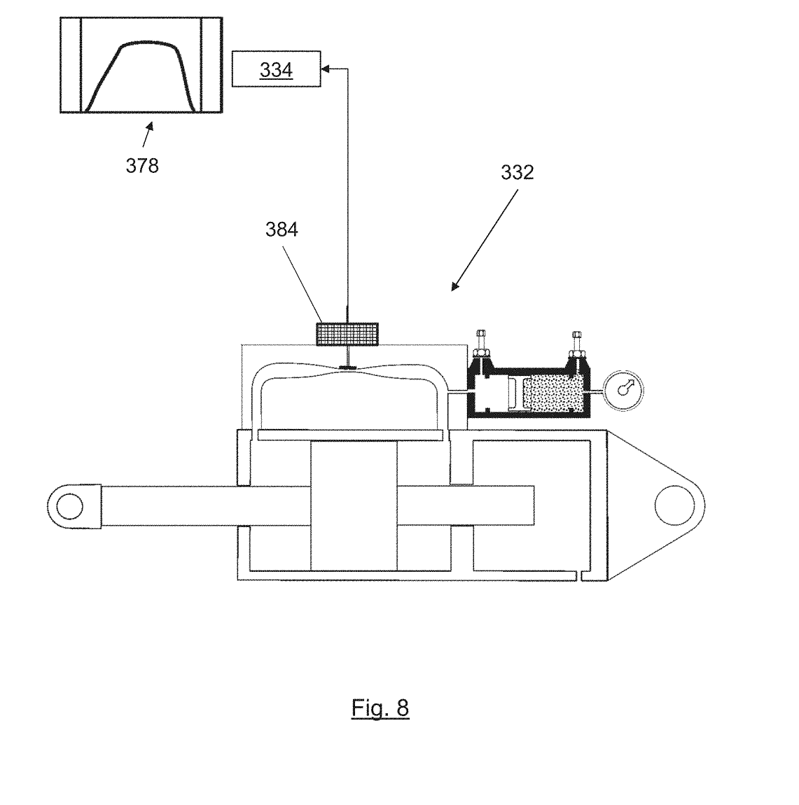

FIG. 8 shows a movement detector 332 according to a third embodiment of the invention. The movement detector 332 is arranged in a similar manner to the movement detector 132 according to the first embodiment. The movement detector 332 differs from the movement detector 132 according to the first embodiment in that the movement detector 332 comprises a sensor in the form of a hot film transducer 384. The hot film transducer 384 being in communication with a control system 334. Graph 378 shows an example of how the speed of fluid flow varies with time over a movement of the link assembly relative to the bogie.

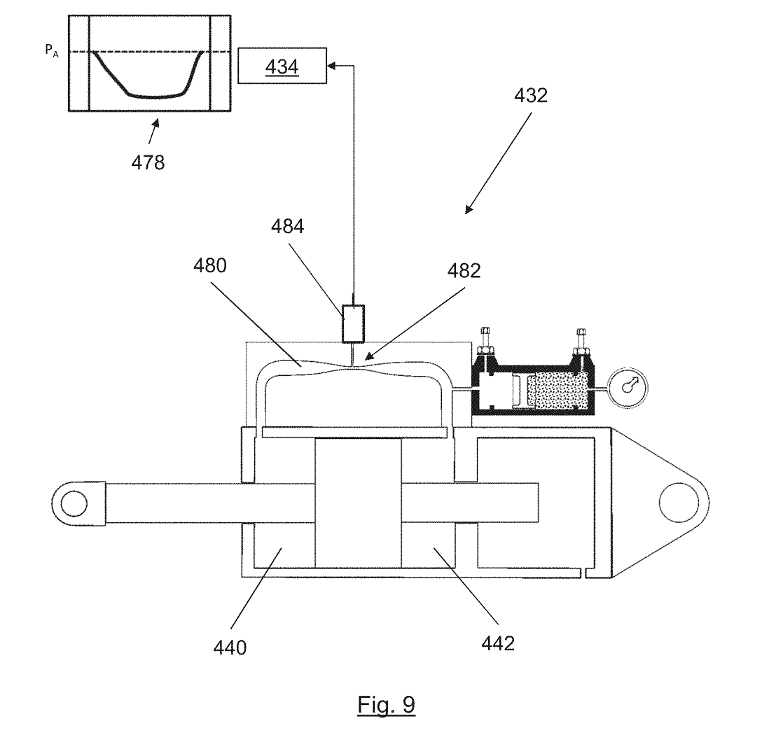

FIG. 9 shows a movement detector 423 according to a fourth embodiment of the invention. The movement detector 432 is arranged in a similar manner to the movement detector 132 according to the first embodiment. The movement detector 432 differs from the movement detector 132 according to the first embodiment in that the movement detector 432 comprises a sensor in the form of a pressure transducer 484. The pressure transducer 484 being in communication with control system 434

When fluid flows through the constricted section 482 of the conduit 480, the pressure of the fluid will decrease (Venturi's principle). Thus when the pressure transducer 484 measures a pressure below the average pressure of the chambers 440, 442 (i.e. below the accumulator pressure, PA) it is indicative of fluid flow and thus movement of the link assembly relative to the bogie. Graph 478 shows an example of how the measured pressure varies with time over a movement of the link assembly relative to the bogie.

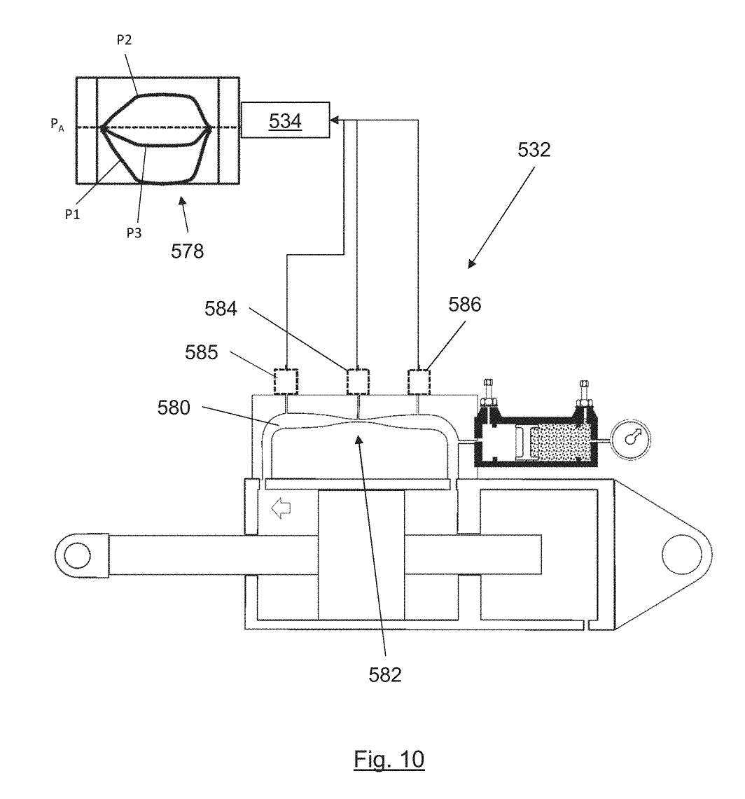

FIG. 10 shows a movement detector 523 according to a fifth embodiment of the invention. The movement detector 532 is arranged in a similar manner to the movement detector 432 according to the fourth embodiment. The movement detector 532 further comprises a second pressure transducer 585 and a third pressure transducer 586, in addition to the first pressure transducer 584. The second and third pressure transducers 585, 586 are arranged to measure the pressure in the conduit 580 either side of the constricted section 582.

When the piston 538 moves within the cylinder 536, one of the chambers decreases in volume, therefore the fluid in that chamber is compressed and the pressure increases. The other chamber increases in volume, therefore the fluid in that chamber expands and the pressure decreases. One of the second and third pressure transducers 585, 586 therefore measures a pressure increase and the other of the second and third pressure transducers 585, 586 measures a pressure decrease. Again, as the fluid flows through the constricted section (as the pressure equalises) the speed of the fluid flow increases and the pressure in the constricted section decreases.

Graph 578 shows an example of how the pressure (P1, P2, P3) measured by the first, second and third transducers 584, 585, 586 varies with time over a movement of the link assembly relative to the bogie. The pressure (P2, P3) measured by the second and third transducers 585, 586 during movement of the piston may differ because the pressure decrease in one chamber may not necessarily match the pressure increase in the other. It may therefore possible to determine the direction of fluid flow in the conduit and therefore the direction of movement of the link assembly relative to the bogie beam.

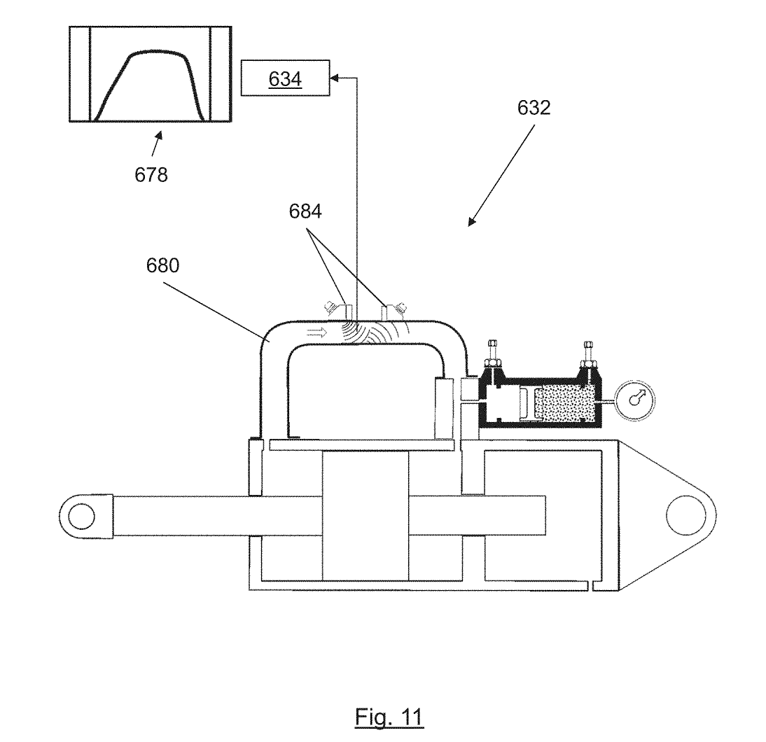

FIG. 11 shows a movement detector 623 according to a sixth embodiment of the invention. The movement detector 632 is arranged in a similar manner to the movement detector 132 according to the first embodiment. The movement detector 632 differs from the movement detector 132 of the first embodiment in that the conduit is in the form of a pipe 680 having a substantially constant diameter. The sensor is in the form of a pair of ultrasonic transducers 684 arranged to measure the velocity of fluid flow in the pipe 680. The ultrasonic transducers 684 are in communication with a control system 634. Graph 678 shows an example of how the speed of fluid flow varies with time over a movement of the link assembly relative to the bogie.

It will be appreciated that the movement detectors of the second to fifth embodiments could be used in the landing gear assembly of the first embodiment by taking the place of the movement detector 132 used therein.

Whilst the present invention has been described and illustrated with reference to particular embodiments, it will be appreciated by those of ordinary skill in the art that the invention lends itself to many different variations not specifically illustrated herein. Some examples of such variations will now be described by way of example only.

In an alternative embodiment the second chamber is located outside the cylinder, the conduit linking the inside and the outside of the cylinder. In other alternative embodiments the movement detector comprises only a single chamber located to one side of the piston, the sensor arranged to sense the movement of the fluid relative to the chamber.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An aircraft landing gear assembly comprising:
a shock absorber strut, a bogie, a link assembly, and a movement detector;
wherein the shock absorber strut comprises an upper telescoping part and a lower telescoping part, the upper telescoping part being connectable to the airframe of an aircraft and the lower telescoping part being connected to the bogie such that the bogie may adopt different pitch angles;
the link assembly extends between the upper and lower telescoping parts, such that relative movement between the upper and lower telescoping parts causes relative movement between parts of the link assembly;
the movement detector is arranged to detect movement of the link assembly relative to the bogie; and
wherein the movement detector comprises:
a piston slidably received within a cylinder, arranged such that relative movement between the link assembly and the bogie causes relative movement of the piston within the cylinder,
fluid which flows as a result of relative movement between the piston and the cylinder, and
a flow sensor arranged to sense a change in flow of the fluid, and
wherein relative movement between the link assembly and the bogie is detected by the flow sensor detecting a change in flow due to movement of the piston within the cylinder.

2. The aircraft landing gear assembly according to claim 1, wherein the cylinder comprises a first chamber, the first chamber being in fluid communication with a second chamber by a conduit, the flow sensor being arranged to sense fluid flow in the conduit, and
wherein movement of the piston within the cylinder causes fluid flow between the first chamber and the second chamber.

3. The aircraft landing gear assembly according to claim 2, wherein the cylinder comprises the second chamber, the first and second chambers being separated by the piston.

4. The aircraft landing gear assembly according to claim 2, wherein the conduit comprises a constricted section and the flow sensor comprises a first pressure transducer arranged to measure the pressure in the conduit at the constricted section.

5. The aircraft landing gear assembly according to claim 2, wherein the conduit comprises a constricted section and the flow sensor comprises a pair of transducers arranged to measure the pressure each side of the constricted section.

6. The aircraft landing gear assembly according to claim 2, wherein the flow sensor is configured to sense the speed of fluid flow in the conduit.

7. The aircraft landing gear assembly according to claim 2, wherein the conduit and flow sensor are detachably mounted to the cylinder.

8. aircraft landing gear assembly according to claim 2, wherein the piston is mounted to a piston rod, the piston rod extending through both the first chamber and the second chamber such that the total volume of the first chamber and the second chamber is constant during movement of the piston in the cylinder.

9. The aircraft landing gear assembly according to claim 1, wherein the flow sensor comprises a hot wire transducer.

10. The aircraft landing gear assembly according to claim 1, wherein the flow sensor comprises a hot film transducer.

11. The aircraft landing gear assembly according to claim 1, wherein the flow sensor comprises a pair of ultrasonic transducers.

12. The aircraft landing gear assembly according to claim 1, wherein the flow sensor is arranged to sense the fluid flow using a static detection methodology.

13. The aircraft landing gear assembly according to claim 1, wherein the movement detector comprises a signal processor arranged to generate a binary output indicating whether or not there is aircraft weight on wheels.

14. The aircraft landing gear assembly according to claim 1, the movement detector further comprising an accumulator arranged to maintain the average pressure of the volume of fluid.

15. An aircraft including the landing gear assembly of claim 1.

16. A method of detecting aircraft weight on wheels during a landing of an aircraft,
wherein the aircraft comprises a control system and a landing gear assembly, the landing gear assembly comprising: a shock absorber strut, a bogie, a link assembly, and a movement detector;
wherein the shock absorber strut comprises an upper and a lower telescoping parts, the upper telescoping part being connected to the airframe of the aircraft and the lower telescoping part being connected to the bogie such that the bogie may adopt different pitch angles;
the link assembly extends between the upper and lower telescoping parts, such that relative movement between the upper and lower telescoping parts causes relative movement between parts of the link assembly;
the bogie supports at least one wheel on at least one axle; and
wherein the movement detector comprises: a piston slidably received within a cylinder, wherein movement of the piston within the cylinder causes fluid to flow in the movement detector, a sensor being arranged to detect the fluid flow;
the method comprising the steps of:
the link assembly moving relative to the bogie during touchdown of the least one wheel thereby causing the piston to move within the cylinder and the fluid to flow;
the sensor sensing the fluid flow;
the control system receiving a signal from the sensor, the signal being indicative of fluid flow; and
the control system determining, on the basis of the signal, that there is aircraft weight on wheels.

17. The method of claim 16 further comprising:
deploying at least one means of slowing the aircraft when the control system determines there to be movement of the link assembly relative to the bogie.

18. A method of determining the rate of descent of an aircraft upon landing,
wherein the aircraft comprises a control system and a landing gear assembly, the landing gear assembly comprising: a shock absorber strut, a bogie, a link assembly, and a movement detector;
wherein the shock absorber strut comprises an upper and a lower telescoping parts, the upper telescoping part being connected to the airframe of the aircraft and the lower telescoping part being connected to the bogie such that the bogie may adopt different pitch angles;
the link assembly extends between the upper and lower telescoping parts, such that relative movement between the upper and lower telescoping parts causes relative movement between parts of the link assembly;
the bogie supports at least one wheel on at least one axle;
wherein the movement detector comprises: a piston slidably received within a cylinder, wherein movement of the piston within the cylinder causes fluid to flow in the movement detector, a sensor being arranged to detect the fluid flow;
the method comprising the steps of:
the link assembly moving relative to the bogie during landing thereby causing the piston to move within the cylinder and the fluid to flow;
the sensor sensing the speed of fluid flow;
the control system receiving a signal from the sensor, the signal being indicative of the speed of fluid flow; and
the control system determining, on the basis of the signal, the rate of descent of the aircraft upon landing.

19. (canceled)
